(19) United States
(12) Patent Application Publication
(10) Pub. No.: US 2007/0235006 A1
(43) Pub. Date: Oct. 11, 2007

(54) Electronic Engine Control Device, Vehicle Equipped with Electronic Engine Control Device, and Electronic Engine Control Method

(75) Inventors: Takahiro Nishigaki, Aichi (JP); Kazuhiro Ichimoto, Aichi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, AICHI (JP)

(21) Appl. No.: 11/597,614

(22) PCT Filed: May 20, 2005
(86) PCT No.: PCT/JP05/09808

§ 371 Date: Dec. 15, 2006

(30) Foreign Application Priority Data
May 28, 2004 (JP) 2004-159405

(51) Int. Cl. F02M 3/08

(52) U.S. Cl. 123/339.1

(57) ABSTRACT

An engine ECU learns a base duty ratio command of an actuator for driving a throttle valve as an operation level of engine control on condition that a target idle rotation speed Nei* enters a predetermined rotation speed range during idling of an engine as one prerequisite. When the learning is incomplete, the engine ECU rejects an up request of the target idle rotation speed Nei* sent from an air conditioner ECU and prohibits the target idle rotation speed Nei* from being changed. The control procedure of the invention effectively prohibits a change of the target idle rotation speed Nei* under the condition of incomplete learning of the operation level of engine control. The prohibition of the change desirably keeps the target idle rotation speed Nei* within the predetermined rotation speed range, thus preventing failed fulfillment of the learning condition and ensuring the sufficient learning opportunities of the operation level of engine control.

### TECHNICAL FIELD

The present invention relates to an electronic engine control device and a vehicle equipped with the electronic engine control device, as well as a corresponding electronic engine control method.

### BACKGROUND ART

The engine is under various drive controls to keep the desired driving conditions. For example, idle rotation speed control computes a difference between an actual engine rotation speed and a target idle rotation speed during an idle operation of the engine, determines an operation amount of an actuator corresponding to the computed difference to make the actual engine rotation speed approach to the target idle rotation speed, and drives the actuator with the determined operation amount to regulate the throttle valve opening. The determined operation amount for drive control of the engine is stored as a learning value to reflect the current desired driving conditions of the engine in a start of a next cycle of drive control. The desired procedure thus learns the operation amount for drive control of the engine and uses the learnt operation amount at a start of a next cycle of drive control, so as to ensure the favorable driving conditions of the engine at the start of the next cycle of drive control.

One proposed electronic engine control device learns the operation amount for drive control of the engine as disclosed in, for example, Japanese Patent Laid-Open Gazette No. 3-141823. In the case of a low-speed drive and the driver's small depression of an accelerator pedal, the vehicle selects a motor mode and stops the engine. In the state of incomplete learning, however, this prior art electronic engine control device does not stop the engine but idles the engine. Another proposed electronic engine control device executes the idle rotation speed control as disclosed in, for example, Japanese Patent Laid-Open Gazette No. 3-160136. This prior art electronic engine control device increases the target idle rotation speed, in response to an up request of the target idle rotation speed sent from a vehicle system other than a vehicle driving system, for example, an air conditioner control unit.

### DISCLOSURE OF THE INVENTION

The unconditional increase in target idle rotation speed in response to the up request of the target idle rotation speed from the air conditioner control unit as disclosed in Japanese Patent Laid-Open Gazette No. 3-160136, however, undesirably reduces the learning opportunities of the operation amount for idle rotation speed control. The learning conditions of the operation amount may be fulfilled, for example, when the target idle rotation speed is within a preset low rotation speed range during the idle operation of the engine. In this case, the increase in target idle rotation speed leads to failed fulfillment of the learning conditions and thereby reduces the learning opportunities of the operation amount. Such a reduction of the learning opportunities is a common problem in other engine drive controls with settings of a target rotation speed within a preset rotation speed range to one of the learning conditions, as well as in any engine drive controls with settings of a difference between the actual engine rotation speed and a target rotation speed within a preset narrow range to one of the learning conditions. The vehicle system other than the vehicle driving system, for example, the air conditioner control unit, may frequently output the up request of the target idle rotation speed, regardless of the current conditions of the vehicle driving system. The frequent output of the up request further reduces the learning opportunities of the operation amount. The reduction of the learning opportunities of the operation amount causes the operation amount stored as the learning value to be old and inadequate and interferes with the optimum engine drive control to keep the desired driving conditions of the engine.

The object of the invention is thus to eliminate the drawbacks of the prior art techniques and to ensure the sufficient learning opportunities of an operation level of engine control in an electronic engine control device and a corresponding electronic engine control method that may change a target idle rotation speed of an engine. The object of the invention is also to provide a vehicle equipped with such an electronic engine control device.

In order to attain at least part of the above and the other related objects, the present invention is directed to an electronic engine control device that controls an engine. The electronic engine control device includes: an operation level learning module that learns an operation level of engine control on condition that a target idle rotation speed is within a predetermined rotation speed range during an idle operation of the engine as one prerequisite; a target rotation speed change module that varies the target idle rotation speed, in response to a change request of the target idle rotation speed sent from a vehicle system other than a vehicle driving system; and a change prohibition module that prohibits the target rotation speed change module from changing the target idle rotation speed, when the learning of the operation level of engine control by the operation level learning module is incomplete.

The electronic engine control device of the invention learns the operation level of engine control on condition that the target idle rotation speed enters the predetermined rotation speed range during the idle operation of the engine as one prerequisite. In the state of incomplete learning, the electronic engine control device rejects the change request of the target idle rotation speed sent from the vehicle system other than the vehicle driving system and prohibits a change of the target idle rotation speed. The vehicle system other than the vehicle driving system may frequently send the change request of the target idle rotation speed, regardless of the current conditions of the vehicle driving system. The arrangement of the invention effectively prohibits a change of the target idle rotation speed under the condition of incomplete learning of the operation level of engine control. The prohibition of the change desirably keeps the target idle rotation speed within the predetermined rotation speed range, thus preventing failed fulfillment of the learning condition and ensuring the sufficient learning opportunities of the operation level of engine control.

Typical examples of the vehicle system other than the vehicle driving system include a heater control system of controlling the operation of a heater, a cooler control system of controlling the operation of a cooler, a negative pressure control system of regulating a brake negative pressure, and a socket control system of controlling a power socket, such as an AC-100V socket.

The present invention is also directed to another electronic engine control device that controls an engine. The electronic engine control device includes: an operation level learning module that learns an operation level of engine control on condition that a difference between an actual rotation speed of the engine and a target idle rotation speed is within a preset narrow range during an idle operation of the engine as one prerequisite; a target rotation speed change module that varies the target idle rotation speed, in response to a change request of the target idle rotation speed sent from a vehicle system other than a vehicle driving system; and a change prohibition module that prohibits the target rotation speed change module from changing the target idle rotation speed, when the learning of the operation level of engine control by the operation level learning module is incomplete.

The electronic engine control device of the invention learns the operation level of engine control on condition that the difference between the actual rotation speed of the engine and the target idle rotation speed is within the preset narrow range during the idle operation of the engine as one prerequisite. In the state of incomplete learning, the electronic engine control device rejects the change request of the target idle rotation speed sent from the vehicle system other than the vehicle driving system and prohibits a change of the target idle rotation speed. The vehicle system other than the vehicle driving system may frequently send the change request of the target idle rotation speed, regardless of the current conditions of the vehicle driving system. The arrangement of the invention effectively prohibits a change of the target idle rotation speed under the condition of incomplete learning of the operation level of engine control. The prohibition of the change desirably keeps the difference between the actual rotation speed of the engine and the target idle rotation speed within the preset narrow range, thus preventing failed fulfillment of the learning condition and ensuring the sufficient learning opportunities of the operation level of engine control.

In the electronic engine control device of the invention having either of the above configurations, it is preferable that the change prohibition module allows the target rotation speed change module to change the target idle rotation speed after the learning of the operation level of engine control by the operation level learning module is completed. This arrangement effectively prevents excessive prohibition of a change in target idle rotation speed and rejects the change request of the target idle rotation speed only in a required range.

In one preferable embodiment of the electronic engine control device of the invention, the engine has a water-cooled mechanism, and the change request is an up request of the target idle rotation speed output from an electronic heater control unit, which controls a heater of recovering waste heat of cooling water in the engine. When the cooling water temperature of the engine is relatively low, the electronic engine control device receives the up request of the target idle rotation speed output from the electronic heater control unit to increase the target idle rotation speed and thereby quickly raise the cooling water temperature of the engine. In the state of incomplete learning of the operation level of engine control, however, this arrangement rejects the up request of the target idle rotation speed and prohibits the increase in target idle rotation speed, thus ensuring the sufficient learning opportunities of the operation level of engine control. The electronic engine control device of this embodiment may further include a stop restart control module that stops the engine upon fulfillment of a preset engine stop condition, while restarting the engine upon subsequent fulfillment of a preset engine restart condition. An auto stop of the engine often leads to the low level of the cooling water temperature of the engine and causes the frequent output of the change request of the target idle rotation speed. The technique of the invention is especially effective in this structure.

In the electronic engine control device of the invention, the engine control may be idle rotation speed control. The idle rotation speed control typically starts learning of the operation level of engine control on condition that the target idle rotation speed enters the predetermined rotation speed range during the idle operation of the engine or that the difference between the actual rotation speed of the engine and the target idle rotation speed enters the preset narrow range during the idle operation of the engine as one prerequisite. The technique of the invention is thus significantly effective in the idle rotation speed control.

In the electronic engine control device of the invention, the operation level of engine control may be a throttle opening or any other parameter relating to the throttle opening. Accumulation of dust in some space or clearance in a throttle valve may vary an intake air flow of the engine and interfere with accurate engine control with the initially set throttle opening. There is accordingly a high demand of learning the operation level of engine control.

In the electronic engine control device of the invention, it is preferable that the operation level of engine control is learnt at least once in each trip or at least once in a preset time period. The appropriate update of the learning value ensures adequate engine control. In the specification hereof, the terminology ‘1 trip’ represents an interval between an ignition on to an ignition off.

Another application of the invention is a vehicle equipped with the electronic engine control device having any of the above arrangements. In the state of incomplete learning of the operation level of engine control, the vehicle prohibits a change of the target idle rotation speed. This arrangement desirably keeps the target idle rotation speed within the predetermined rotation speed range or keeps the difference between the actual rotation speed of the engine and the target idle rotation speed within the preset narrow range, thus preventing failed fulfillment of the learning condition and ensuring the sufficient learning opportunities of the operation level of engine control.

The present invention is also directed to an electronic engine control method that controls an engine. The electronic engine control method includes the steps of: (a) learning an operation level of engine control on condition that a target idle rotation speed is within a predetermined rotation speed range during an idle operation of the engine as one prerequisite; and (b) prohibiting the target idle rotation speed from being changed in response to a change request of the target idle rotation speed sent from a vehicle system other than a vehicle driving system, when the learning of the operation level of engine control in the step (a) is incomplete.

The vehicle system other than the vehicle driving system may frequently send the change request of the target idle rotation speed, regardless of the current conditions of the vehicle driving system. The electronic engine control method of the invention effectively prohibits a change of the target idle rotation speed under the condition of incomplete learning of the operation level of engine control. The prohibition of the change desirably keeps the target idle rotation speed within the predetermined rotation speed range, thus preventing failed fulfillment of the learning condition and ensuring the sufficient learning opportunities of the operation level of engine control.

The present invention is further directed to an electronic engine control method that controls an engine. The electronic engine control method includes the steps of: (a) learning an operation level of engine control on condition that a difference between an actual rotation speed of the engine and a target idle rotation speed is within a preset narrow range during an idle operation of the engine as one prerequisite; and (b) prohibiting the target idle rotation speed from being changed in response to a change request of the target idle rotation speed sent from a vehicle system other than a vehicle driving system, when the learning of the operation level of engine control in the step (a) is incomplete.

The vehicle system other than the vehicle driving system may frequently send the change request of the target idle rotation speed, regardless of the current conditions of the vehicle driving system. The electronic engine control method of the invention effectively prohibits a change of the target idle rotation speed under the condition of incomplete learning of the operation level of engine control. The prohibition of the change desirably keeps the difference between the actual rotation speed of the engine and the target idle rotation speed within the preset narrow range, thus preventing failed fulfillment of the learning condition and ensuring the sufficient learning opportunities of the operation level of engine control.

In the electronic engine control method of the invention having either of the above configurations, it is preferable that the step (b) allows the target idle rotation speed to be changed in response to the change request of the target idle rotation speed after the learning of the operation level of engine control is completed in the step (a). This arrangement effectively prevents excessive prohibition of a change in target idle rotation speed and rejects the change request of the target idle rotation speed only in a required range.

### BRIEF DESCRIPTION OF THE DRAWINGS

FIG. 1 schematically illustrates the configuration of a hybrid vehicle 10 in one embodiment of the invention;

FIG. 2 schematically shows the structure of an engine 20 mounted on the hybrid vehicle 10;

FIG. 3 is a flowchart showing a hybrid control routine;

FIG. 4 shows an example of torque demand setting map;

FIG. 5 shows a process of setting the optimum drive point;

FIG. 6 is an example of an alignment chart for determining the rotation speed of a shaft;

FIG. 7 is a flowchart showing an idle rotation speed control routine;

FIG. 8 is a flowchart showing a modified idle rotation speed control routine;

FIG. 9 schematically illustrates the configuration of a hybrid vehicle in one modified structure; and

FIG. 10 schematically illustrates the configuration of a hybrid vehicle in another modified structure.

### BEST MODES OF CARRYING OUT THE INVENTION

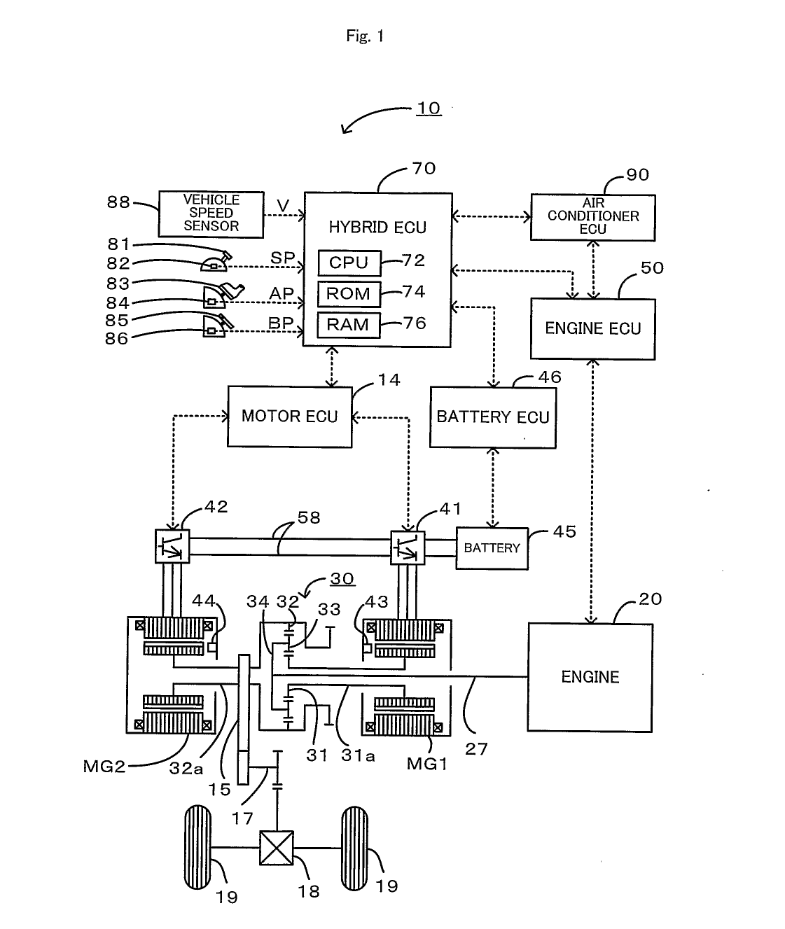

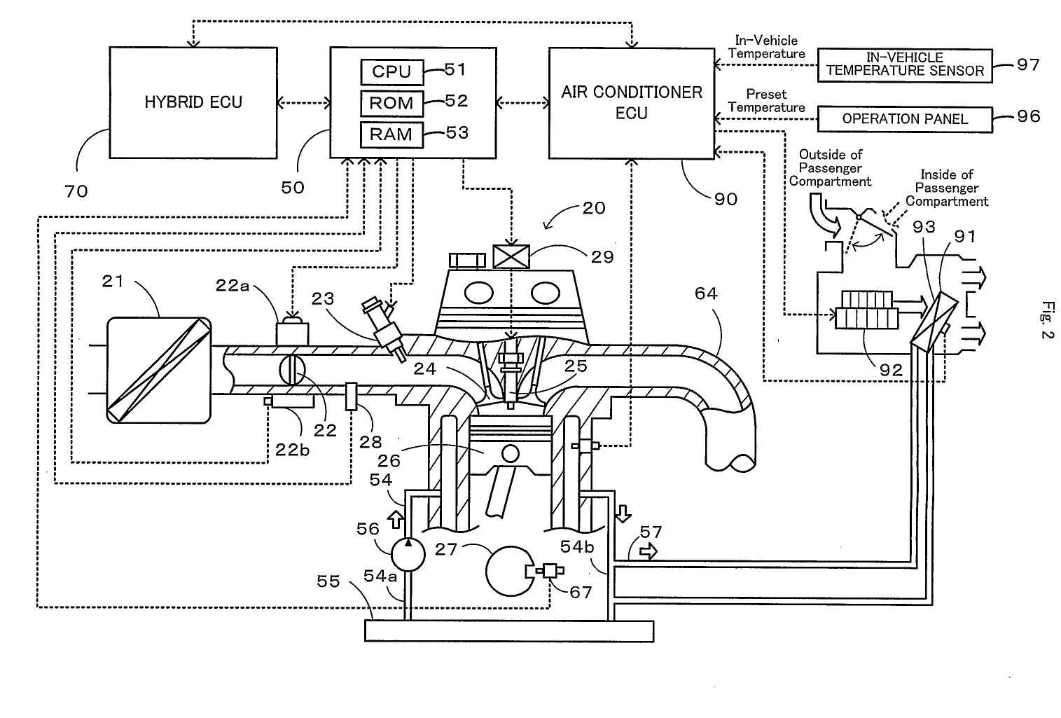

FIG. 1 schematically illustrates the configuration of a hybrid vehicle 10 in one embodiment of the invention. FIG. 2 schematically shows the structure of an engine 20 mounted on the hybrid vehicle 10 of the embodiment.

As illustrated in FIG. 1, the hybrid vehicle 10 includes the engine 20 that converts combustion energy generated by combustion of a fuel into kinetic energy, an engine electronic control unit (engine ECU) 50 that controls the whole engine system, a three shaft-type power distribution integration mechanism 30 that is linked to a crankshaft 27 or an output shaft of the engine 20, motors MG1 and MG2 that are connected to the power distribution integration mechanism 30 and are capable of generating electric power, and a motor electronic control unit (motor ECU) 14 that controls power generation and actuation of the motors MG1 and MG2. The hybrid vehicle 10 also includes a battery 45 that transmits electric power to and from the motors MG1 and MG2, a battery electronic control unit (battery ECU) 46 that monitors the charging conditions of the battery 45, a drive shaft 17 that is linked via a chain belt 15 to a shaft connecting with the power distribution integration mechanism 30, a hybrid electronic control unit (hybrid ECU) 70 that controls the whole hybrid system, and an air conditioner electronic control unit (air conditioner ECU) 90 that controls the temperature in a passenger compartment. The drive shaft 17 is connected to drive wheels 19,19 via a differential gear 18.

The engine 20 is an internal combustion engine that consumes a hydrocarbon fuel, such as gasoline, to output power. As shown in FIG. 2, the engine 20 receives a supply of the air cleaned by an air cleaner 21 and ingested via a throttle valve 22, while receiving a supply of gasoline injected by an injector 23. The supplies of the intake air and the injected gasoline are mixed to an air-fuel mixture, which is introduced-into a combustion chamber via an intake valve 24 and is ignited for explosive combustion with an electric spark of an ignition plug 25. Reciprocating motions of a piston 26 by means of combustion energy of the explosive combustion are converted into kinetic energy of rotating the crankshaft 27. A crank angle sensor 67 is attached to the crankshaft 27 to output a pulse at every crank angle of 10° CA. The throttle valve 22 varies its inclination angle (opening) relative to the cross section of an intake conduit to regulate the air flow passing through the intake conduit. The opening of the throttle valve 22 is electrically varied by an actuator 22a, which is a rotary solenoid. Duty control of a voltage level applied to the solenoid rotates the throttle valve 22 and thereby regulates the opening of the throttle valve 22. The opening of the throttle valve 22 is output from a throttle position sensor 22b to the engine ECU 50. Exhaust of the engine 20 flows through an exhaust conduit 64 and is discharged outside the hybrid vehicle 10 via a catalytic converter (not shown).

The engine 20 is constructed as a water-cooled engine and has a circulation path 54 to make a flow of cooling water and cool down the inside of the engine 20. The circulation path 54 includes a first pipe 54a that introduces the flow of cooling water after heat removal from the engine 20 to a radiator 55, and a second pipe 54b that recirculates the flow of cooling water after heat radiation by the radiator 55 to the engine 20. A cooling water circulation pump 56 is located in the middle of the second pipe 54b and works to circulate the flow of cooling water through the circulation path 54. The first pipe 54a has a bypass 57, and a heater core 91 functioning as a heat exchange unit is connected to the middle of the bypass 57. A blower 92 takes the outside air or the inside air of the passenger compartment into the heat core 91. The air flowing through the heater core 91 receives heat from the hot flow of cooling water heated in the engine 20 and is accordingly heated to the warm air, which is blown out of an air outlet into the passenger compartment. Namely the hybrid vehicle 10 of the embodiment recovers the waste heat of the cooling water flow in the engine 20 for the heater function. A heater core temperature sensor 93 is attached to the heater core 91 to measure the temperature of the cooling water flow in the heater core 91. The circulation path 54 has a cooling water temperature sensor (not shown) to measure the temperature of cooling water.

The engine ECU 50 is constructed as a microprocessor including a CPU 51, a ROM 52 that stores various processing programs, a RAM 53 that temporarily stores data, and input and output ports (not shown). The engine ECU 50 receives diverse signals representing the present conditions of the engine 20 from various sensors via its input port. For example, the engine ECU 50 receives, via its input port, an air intake flow of the engine 20 from an air flow meter 28, a throttle opening from the throttle position sensor 22b, a cooling water temperature of the engine 20 from the cooling water temperature sensor, a pulse signal from the crank angle sensor 67, and an up request of a target idle rotation speed Nei* from the air conditioner ECU 90. The engine ECU 50 outputs diversity of drive signals and control signals to drive and control the engine 20 via its output port. For example, the engine ECU 50 outputs, via its output port, drive signals to the actuator 22a for actuating the throttle valve 22 and to the injector 23 and control signals to an ignition coil 29 integrated with an igniter for igniting the spark plug 25. The engine ECU 50 is electrically connected with the hybrid ECU 70 and receives control signals from the hybrid ECU 70 to drive and control the engine 20, while outputting data regarding the driving conditions of the engine 20 to the hybrid ECU 70 according to the requirements.

The power distribution integration mechanism 30 includes a sun gear 31 that is linked to the motor MG1, a ring gear 32 that is linked to the motor MG2, multiple pinion gears 33 that engage with the sun gear 31 and with the ring gear 32, and a carrier 34 that is connected to the crankshaft 27 of the engine 20 and holds the multiple pinion gears 33 to allow both their revolutions and their rotations on their axes. The power distribution integration mechanism 30 accordingly forms a planetary gear mechanism of the sun gear 31, the ring gear 32, and the carrier 34 as rotational elements of differential motions. When the motor MG1 functions as a generator, the power distribution integration mechanism 30 distributes the output power of the engine 20 into the motor MG1 and the drive shaft 17 corresponding to a gear ratio of the sun gear 31 and the ring gear 32. When the motor MG2 functions as a motor, on the other hand, the power distribution integration mechanism 30 integrates the output power of the engine 20 with the output power of the motor MG2 and outputs the integrated power to the drive shaft 17.

The motors MG1 and MG2 are constructed as known synchronous motor generators that may be actuated both as a generator and as a motor. The motors MG1 and MG2 transmit electric powers to and from the battery 45 via inverters 41 and 42. Power lines 58 connecting the battery 45 with the inverters 41 and 42 are structured as common positive bus and negative bus shared by the inverters 41 and 42. Such connection enables electric power generated by one of the motors MG1 and MG2 to be consumed by the other motor MG2 or MG1. The battery 45 may thus be charged with surplus electric power generated by either of the motors MG1 and MG2, while being discharged to supplement insufficient electric power of either of the motors MG1 and MG2. Both the motors MG1 and MG2 are driven and controlled by the motor ECU 14. The motor ECU 14 receives signals required for driving and controlling the motors MG1 and MG2, for example, signals representing rotational positions of rotors in the motors MG1 and MG2 from rotational position detection sensors 43 and 44 and signals representing phase currents to be applied to the motors MG1 and MG2 from electric current sensors (not shown). The motor ECU 14 outputs switching control signals to the inverters 41 and 42. The motor ECU 14 executes a rotation speed computation routine (not shown) to calculate rotation speeds Nm1 and Nm2 of the respective rotors in the motors MG1 and MG2 from the input signals of the rotational position detection sensors 43 and 44. The calculated rotation speeds Nm1 and Nm2 are respectively equivalent to a rotation speed Ns of a sun gear shaft 31a and a rotation speed Nr of a ring gear shaft 32a, since the motor MG1 is linked to the sun gear 31 and the motor MG2 is linked to the ring gear 32. The motor ECU 14 establishes communication with the hybrid ECU 70 and receives control signals from the hybrid ECU 70 to drive and control the motors MG1 and MG2, while outputting data regarding the driving conditions of the motors MG1 and MG2 to the hybrid ECU 70 according to the requirements.

The battery 45 used in this embodiment is a nickel hydride battery and functions to supply electric power to the motors MG1 and MG2 and accumulate the regenerative energy from the motors MG1 and MG2 during deceleration in the form of electric power. The battery ECU 46 receives signals required for management of the battery 45, for example, an inter-terminal voltage from a voltage sensor (not shown) located between terminals of the battery 45, a charge-discharge electric current from an electric current sensor (not shown) located in a power line connecting with an output terminal of the battery 45, and a battery temperature from a temperature sensor (not shown) attached to the battery 45. The battery ECU 46 outputs data regarding the conditions of the battery 45 to the hybrid ECU 70 by communication according to the requirements. For management of the battery 45, the battery ECU 46 computes a remaining charge level or current state of charge (SOC) of the battery 45 from an integration of the charge-discharge electric current measured by the electric current sensor and the inter-terminal voltage measured by the voltage sensor.

The hybrid ECU 70 is constructed as a microprocessor including a CPU 72, a ROM 74 that stores processing programs, a RAM 76 that temporarily stores data, and a non-illustrated input-output port. The hybrid ECU 70 receives various inputs via the input port: a gearshift position SP from a gearshift position sensor 82 that detects the current position of a gearshift lever 81, an accelerator opening AP from an accelerator pedal position sensor 84 that measures a step-on amount of an accelerator pedal 83, a brake pedal position BP from a brake pedal position sensor 86 that measures a step-on amount of a brake pedal 85, and a vehicle speed V from a vehicle speed sensor 88. The hybrid ECU 70 communicates with the engine ECU 50 and the motor ECU 14. The hybrid ECU computes state of charge (SOC) of the battery 45 from an accumulated value of the charge discharge electric current measured by a non-illustrated electric current sensor.

The air conditioner ECU 90 is a one of the vehicle systems other than the vehicle driving system and is constructed as a microprocessor including a CPU. The air conditioner ECU 90 receives a preset temperature on an air conditioner operation panel 96, an in-vehicle temperature or temperature of the passenger compartment from an in-vehicle temperature sensor 97, and a heater core temperature from the heater core temperature sensor 93 attached to the heater core 91. The heater core temperature represents the temperature of the heater core 91 that exchanges heat with the cooling water flow in the engine 20, and is thus equivalent to the cooling water temperature of the engine 20. The air conditioner ECU 90 outputs a driving signal to the blower 92 to regulate the air flow and the up request of the target idle rotation speed Nei* to the engine ECU 50. The air conditioner ECU 90 is electrically connected with the hybrid ECU 70 to output air conditioning-related data to the hybrid ECU 70.

The following describes a hybrid control routine executed by the hybrid ECU 70 and an engine control routine executed by the engine ECU 50 in the hybrid vehicle 10 of the embodiment having the configuration discussed above.

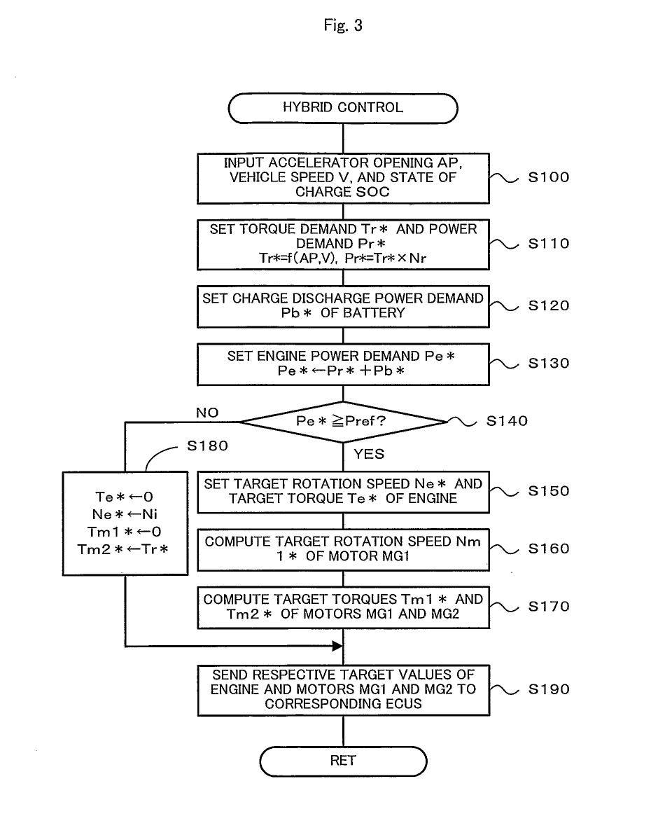

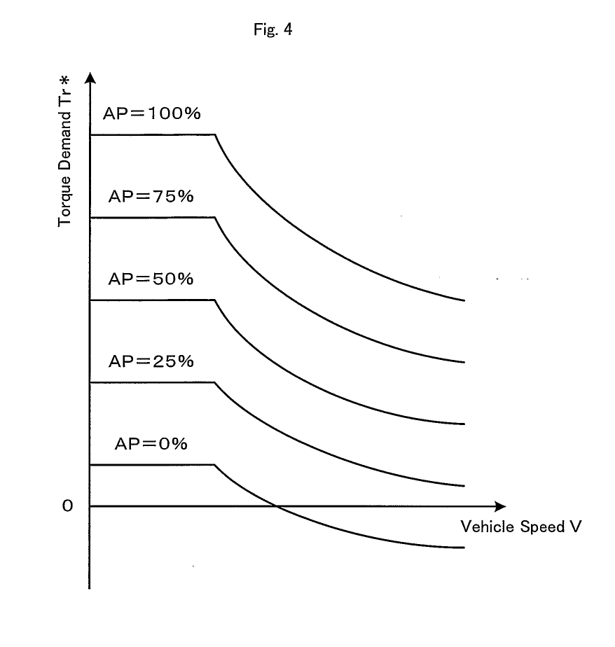

The hybrid control routine executed by the hybrid ECU 70 is described first with reference to the flowchart of FIG. 3. The hybrid control routine is carried out repeatedly at preset timings. In the hybrid control routine, the CPU 72 of the hybrid ECU 70 first inputs signals required for control, that is, the accelerator opening AP, the vehicle speed V, and the remaining charge or state of charge (SOC) of the battery 45 computed by the battery ECU 46 (step S100) and sets a torque demand Tr* and a power demand Pr* to be output to the ring gear shaft 32a, based on the input accelerator opening AP and the input vehicle speed V (step S110). The concrete procedure of the embodiment for setting the power demand Pr* stores in advance variations in torque demand Tr* against the accelerator opening AP and the vehicle speed V as a torque demand setting map in the ROM 74 of the hybrid ECU 70, reads the torque demand Tr* corresponding to the given accelerator opening AP and the given vehicle speed V from the torque demand setting map, and computes the power demand Pr* as the product of the torque demand Tr* and the rotation speed Nr of the ring gear shaft 32a (equal to the product of the vehicle speed V and a conversion factor r). One example of the torque demand setting map is shown in FIG. 4.

The CPU 72 subsequently sets a charge discharge power demand Pb* of the battery 45 (positive values for charging and negative values for discharging) (step S120). The charge-discharge power demand Pb* of the battery 45 is typically set to keep the SOC of the battery 45 in an adequate range (for example, 60 to 70%). The power demand Pr* and the charge-discharge power demand Pb* are summed up as an engine power demand Pe* to be output from the engine 20 (step S130).

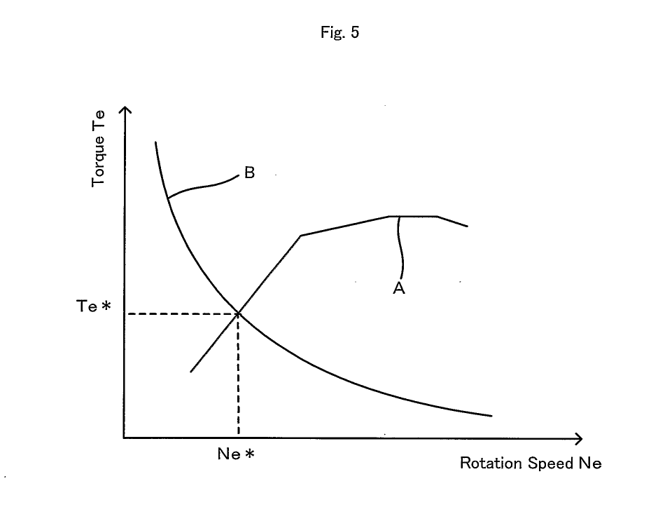

The engine power demand Pe* of the engine 20 is compared with a preset minimum power level Pref (step S140). The minimum power level Pref is determined empirically on the ground that the output power level of the engine 20 below the minimum power level Pref lowers the total system efficiency of the hybrid vehicle 10. When the engine power demand Pe* is not lower than the preset minimum power level Pref at step S140, an optimum drive point of ensuring the most efficient operation of the engine 20 is set to a target torque Te* and a target rotation speed Ne* of the engine 20, among possible drive points of the engine 20 for output of the engine power demand Pe* (drive points defined by the combinations of the torque and the rotation speed) (step S150). FIG. 5 shows a process of setting the optimum drive point of ensuring the most efficient operation of the engine 20 among the possible drive points for output of the engine power demand Pe* to the target torque Te* and the target rotation speed Ne*. A curve A represents an optimum engine operation line, and a curve B represents a constant power curve of the engine power demand Pe*. The power is expressed by the product of the torque and the rotation speed. The constant power curve B accordingly has an inverse proportional profile. As clearly understood from this graph, the operation of the engine 20 at the optimum drive point, which is the intersection of the optimum engine operation line A and the constant power curve B of the engine power demand Pe*, ensures the efficient output of the engine power demand Pe* from the engine 20. The concrete procedure of the embodiment experimentally or otherwise specifies in advance a variation in optimum drive point against the engine power demand Pe* and stores the variation as a map in the ROM 74 of the hybrid ECU 70. The rotation speed and the torque at an optimum drive point corresponding to the given engine power demand Pe* are read from the map and are set to the target rotation speed Ne* and the target torque Te*.

After setting the target torque Te* and the target rotation speed Ne*, the CPU 72 calculates a target rotation speed Nm1* of the motor MG1 from the target rotation speed Ne* of the engine 20, the rotation speed Nr of the ring gear shaft 32a, and a gear ratio ρ (=the number of teeth of the sun gear 31/the number of teeth of the ring gear 32) of the power distribution integration mechanism 30 according to Equation (1) given below (step S160). The CPU 72 also computes a target torque Tm1* of the motor MG1 from the target torque Te* of the engine 20 and the gear ratio ρ of the power distribution integration mechanism 30 according to Equation (2) given below, while computing a target torque Tm2* of the motor MG2 from the target torque Te* of the engine 20, the gear ratio ρ of the power distribution integration mechanism 30, and the torque demand Tr* according to Equation (3) given below (step S170):
Nm1*=(1+ρ)×Ne*/ρ−Nr/ρ (1)
Tm1*=−Te*×ρ/(1+ρ) (2)
Tm2*=Tr*−Te*×1/(1+ρ) (3)

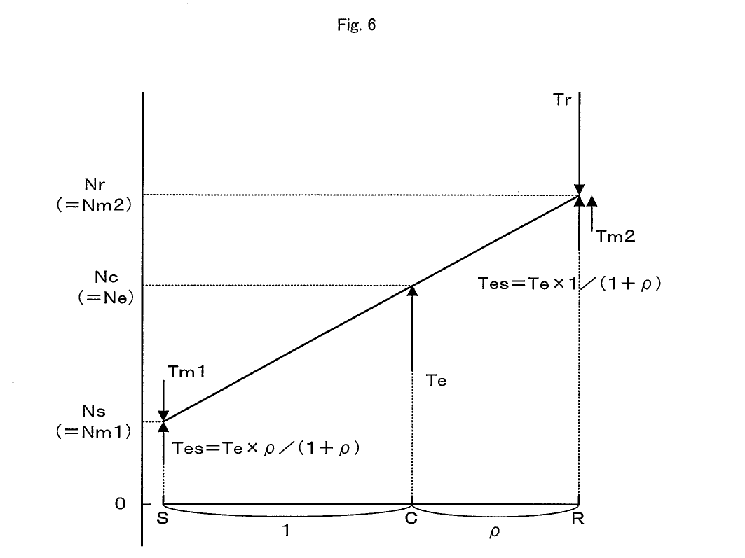

FIG. 6 is an alignment chart with the rotation speeds of the respective rotating shafts as the ordinate and the gear ratio of the respective gears as the abscissa. The crankshaft 27 or carrier shaft (expressed by C) is located at a position of internally dividing the interval between the two end positions of the sun gear shaft 31a (expressed by S) and the ring gear shaft 32a (expressed by R) at 1 to ρ. The rotation speeds Ns, Nc, and Nr are plotted corresponding to the respective positions S, C, and R. The power distribution integration mechanism 30 is the planetary gear mechanism as mentioned above, so that these three plots are aligned. This line is called the collinear line. The use of this collinear line automatically determines the rotation speed of a residual shaft based on the preset rotation speeds of any two among the three rotating shafts. The rotation speed Nr of the ring gear shaft 32a (equivalent to the rotation speed Nm2 of the motor MG2) depends on the vehicle speed V. Determination of the rotation speed Nc of the carrier shaft (equivalent to the rotation speed Ne of the engine 20) thus automatically sets the rotation speed Ns of the sun gear shaft 31a (equivalent to the rotation speed Nm1 of the motor MG1) by the proportional division as shown by Equation (1) given above. Substitution of the torques applied on the respective rotating shafts by forces acting on the collinear line proves that the collinear line is balanced as a rigid body. Here it is assumed that a torque Te applied on the crankshaft 27 of the engine 20 is expressed by an upward vector at the position C relative to the collinear line and that a torque Tr applied on the ring gear shaft 32a is expressed by a downward vector at the position R. The direction of each vector represents the acting direction of the torque. Based on the distribution law of the force applied on the rigid body, the torque Te is distributed to both the end positions S and R. A distributive torque Tes at the position S is expressed by an upward vector having a magnitude of Te×ρ/(1+ρ), whereas a distributive torque Ter at the position R is expressed by an upward vector having a magnitude of Te×1/(1+ρ). The collinear line is balanced as the rigid body under such conditions. The torque Tm1 to be applied to the motor MG1 accordingly has the same magnitude as but the opposite direction to those of the distributive torque Tes. The torque Tm2 to be applied to the motor MG2 is equal to a difference between the torque Tr and the distributive torque Ter.

After setting the target rotation speed Ne* and the target torque Te* of the engine 20, the target rotation speed Nm1* and the target torque Tm1* of the motor MG1, and the target torque Tm2* of the motor MG2, the CPU 72 sends these target values to the engine ECU 50 and the motor ECU 14 (step S190) and terminates the hybrid control routine. The engine ECU 50 and the motor ECU 14 respectively drive and control the engine 20 and the motors MG1 and MG2, based on the received target values. The drive control of the engine ECU 50 sets an air flow required for the engine 20 to rotate at the target rotation speed Ne* and output the target torque Te*, computes an amount of intake air per rotation of the engine 20 from the required air flow, and controls the actuator 22a to rotate the throttle valve 22 and regulate the throttle opening corresponding to the computed amount of intake air. The drive control of the engine ECU 50 also calculates a required amount of fuel injection or a fuel injection time by the injector 23 from a preset target air-fuel ratio (for example, stoichiometric air-fuel ratio) corresponding to the computed amount of intake air, opens the valve of the injector 23 to allow fuel injection for the computed fuel injection time, and applies a high-voltage to the ignition coil 29 to cause the ignition plug 25 to generate a spark and ignite the air-fuel mixture ingested by the intake valve 24. The piston 26 moves up and down by means of the generated combustion energy. The vertical motions of the piston 26 are converted to rotational motions of the crankshaft 27.

When the engine power demand Pe* of the engine 20 is lower than the preset minimum power level Pref at step S140, on the other hand, the CPU 72 sets both the target torque Te* of the engine 20 and the target torque Tm1* of the motor MG1 to zero, the target rotation speed Ne* of the engine 20 to an idle rotation speed Ni, and the target torque Tm2* of the motor MG2 to the torque demand Tr* (step S180). The CPU 72 then sends the target torque Te* and the target rotation speed Ne* of the engine 20, the target torque Tm1* of the motor MG1, and the target torque Tm2* of the motor MG2 to the engine ECU 50 and the motor ECU 14 (step S190), and terminates the hybrid control routine. Setting of the target torque Te* of the engine 20 to zero leads to setting of the engine power demand Pe* to zero. Setting of the target torque Tm1* of the motor MG1 to zero causes no-load operation (idling) of the motor MG1, while setting of the target torque Te* of the engine 20 to zero causes no-load operation (idling) of the engine 20. The target torque Tr* of the ring gear shaft 32a is thus all supplied by the motor MG2. Regulation of the inverter 41 to set the rotational resistance of the rotor in the motor MG1 to zero attains the no-load operation of the motor MG1. The idle rotation speed Ni is appropriately varied according to the driving conditions of the engine 20 by the engine ECU 50.

Engine stop conditions are fulfilled, for example, when the engine 20 is in a low load zone of the poor engine efficiency (for example, in a range of low vehicle speed V) and when the battery 45 has the desired SOC (state of charge). Upon fulfillment of the engine stop conditions, the engine ECU 50 executes a series of engine stop operations to stop the fuel injection by the injector 23 and prohibit the ignition of the spark plug 25. Engine restart conditions are fulfilled, for example, when the output powers of both the engine 20 and the motor MG2 are required to drive the wheels (for example, under acceleration) or when the low SOC of the battery 45 requires power generation of the motor MG1 to charge the battery 45. Upon fulfillment of the engine restart conditions, the engine ECU 50 controls the motor MG1 to crank the engine 20, regulates the valve-opening time of the injector 23 to ensure fuel injection by the injector 23 to a required level for a restart of the engine 20, and allows the ignition of the spark plug 25, so as to restart the engine 20.

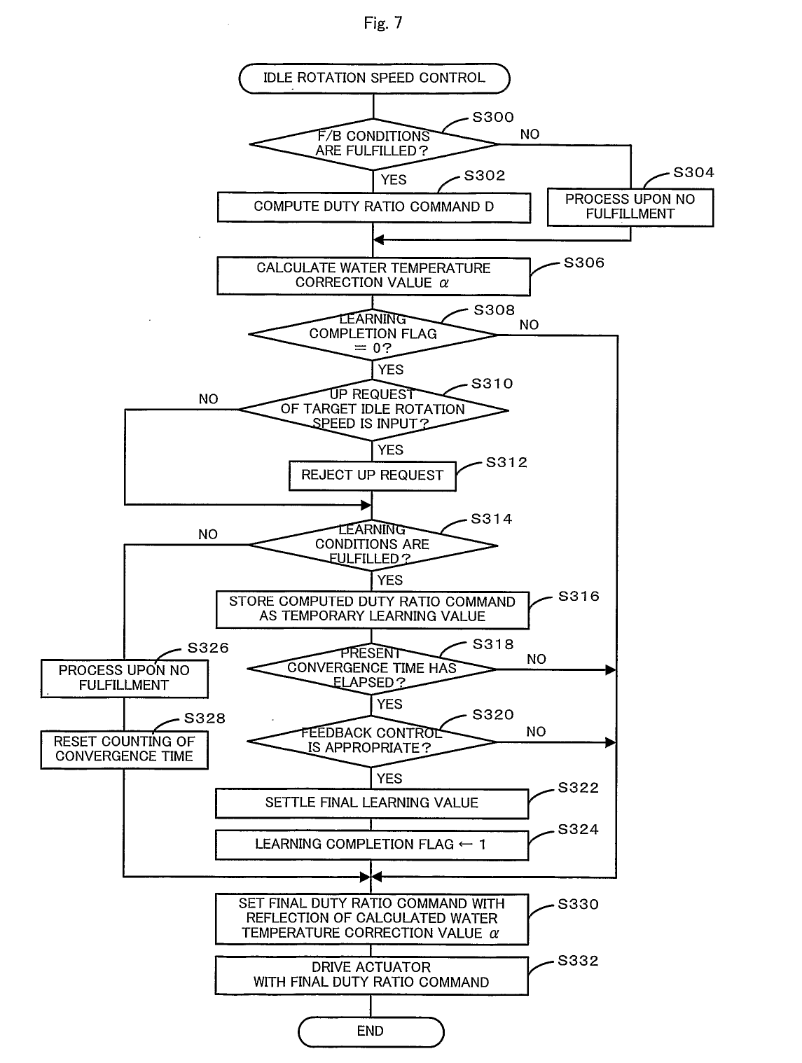

An idle rotation speed control routine executed by the engine ECU 50 is described below with reference to the flowchart of FIG. 7. This idle rotation speed control routine is carried out repeatedly at preset timings (for example, at every several msec or at every preset crank angle). In the idle rotation speed control routine, the engine ECU 50 (CPU 51) first determines whether predetermined feedback conditions are fulfilled (step S300). In the flowchart of FIG. 7, the terminology ‘feedback’ is abbreviated by F/B. The feedback conditions are fulfilled, for example, when the cooling water temperature of the engine 20 measured by the cooling water temperature sensor is not lower than 65° C. and shows sufficient warm-up of the engine 20 or when the engine 20 has the target torque Te* set equal to zero by the hybrid ECU 70 and idles. When the predetermined feedback conditions are fulfilled at step S300, the engine ECU 50 computes a duty ratio command D as a reference operation amount of the actuator 22a in feedback control of the idle rotation speed (step S302). The feedback control of the idle rotation speed adjusts the full-close position of the throttle valve 22 through the duty control of the voltage level applied to the solenoid of the actuator 22a, in order to make the actual engine rotation speed Ne computed from the output value of the crank angle sensor 67 approach to the target idle rotation speed Nei*. The engine ECU 50 computes the duty ratio command D used for this duty control. The duty ratio command D is calculated by adding a feedback correction value β to a preset base duty ratio command Dbase. The feedback correction value β may be determined by known PI control according to a difference ΔNe between the actual engine rotation speed Ne and the target idle rotation speed Nei* during idling of the engine 20. When the predetermined feedback conditions are not fulfilled at step S300, on the other hand, the engine ECU 50 performs a process upon no fulfillment of the feedback conditions (step S304). This process reads out a previous base duty ratio command Dbase stored previously in the RAM 53 and sets the previous base duty ratio command Dbase to the duty ratio command D.

After the processing of either step S302 or step S304, the engine ECU 50 receives the cooling water temperature of the engine 20 from the cooling water temperature sensor and calculates a water temperature correction value α from the received cooling water temperature (step S306). The water temperature correction value α is set to decrease with an increase in observed cooling water temperature. After calculation of the water temperature correction value α, the engine ECU 50 determines whether learning has been completed in a current trip, based on a learning completion flag F (step S308). The learning completion flag F is set to 1 that represents completed learning in one trip, while being reset to 0 that represents incomplete learning. The initial value of the learning completion flag F is 0. In response to the learning completion flag F equal to 0 at step S308, the engine ECU 50 determines whether an up request of the target idle rotation speed Nei* is received from the air conditioner ECU 90 (step S310). The air conditioner ECU 90 outputs the up request of the target idle rotation speed Nei* to the engine ECU 50 in order to introduce the hot flow of cooling water of the engine 20 into the heater core 91 and raise the temperature of the air flow in the heater core 91 in the case where the cooling water temperature of the engine 20 is low and the set temperature of the air conditioner is higher than the actual temperature of the passenger compartment, for example, at an ignition-on time in cold climates.

The engine ECU 50 rejects the up request of the target idle rotation speed Nei* input from the air conditioner ECU 90 at step S310 to keep the target idle rotation speed Nei* unchanged at the current level (step S312) and subsequently determines whether learning conditions are fulfilled (step S314). In the case of no input of the up request of the target idle rotation speed Nei* from the air conditioner ECU 90 at step S310, on the other hand, the engine ECU 50 directly goes to step S314. The learning conditions are fulfilled, for example, when the cooling water temperature is not lower than 70° C., the target idle rotation speed Nei* enters a predetermined rotation speed range (for example, a range of 900 to 975 rpm), and the rotation speed difference ΔNe is within a preset narrow range (for example, within a range of ±75 rpm) during execution of the idle rotation speed control routine. Namely the learning conditions are fulfilled when the engine 20 is sufficiently warmed up and the actual rotation speed Ne of the engine 20 is favorably converged to the target idle rotation speed Nei* in the predetermined rotation speed range by the feedback control. Upon fulfillment of the learning conditions at step S314, the duty ratio command D (=Dbase+A) computed at step S302 is set to a temporary learning value and is stored in a specified area of the RAM 53 (step S316). The engine ECU 50 then determines whether a preset convergence time has elapsed since the fulfillment of the learning conditions (step S318). The convergence time is set to a sufficient time period that ensures convergence of the actual rotation speed Ne of the engine 20 to the target idle rotation speed Nei* by the feedback control of the idle rotation speed.

In the case of elapse of the preset convergence time since the fulfillment of the learning conditions at step S318, the engine ECU 50 subsequently determines whether the feedback control of the idle rotation speed has been implemented appropriately (step S320). It is determined at step S320 that the feedback control is sufficiently appropriate when the rotation speed difference ΔNe enters a predetermined narrow range (for example, a range of ±50 rpm). In the case of the determination of sufficiently appropriate feedback control based on the rotation speed difference ΔNe within the predetermined narrow range at step S320, the temporary learning value stored in the RAM 53 is settled as a final learning value and is set to the base duty ratio command Dbase (step S322). The learning completion flag F is then set to 1 to represent completion of the learning (step S324). When the learning conditions are not fulfilled at step S314, on the other hand, the ECU 50 executes a process upon no fulfillment of the learning conditions to prohibit storage of the duty ratio command D computed at step S302 in the RAM 53 (step S326) and resets the counting of the convergence time (step S328).

The control flow goes to step S330 after setting of the learning completion flag F to 1 at step S324, in response to the learning completion flag F equal to 1 that represents the completed learning at step S308, in the case of no elapse of the preset convergence time since the fulfillment of the learning conditions at step S318, in the case of the determination of inappropriate feedback control at step S320, or after resetting the counting of the convergence time at step S328. The engine ECU 50 adds the water temperature correction value α calculated at step S306 to the duty ratio command D to settle a final duty ratio command Dfinal (=D+α=Dbase +β+α) (step S330), drives the actuator 22a with the settled final duty ratio command Dfinal (step S332), and terminates this idle rotation speed control routine. This controls the actuator 22a to adjust the full close position of the throttle valve 22 and ensures the desired intake air flow into the engine 20 to make the actual rotation speed Ne of the engine 20 approach to the target idle rotation speed Nei*.

As described above, the control procedure of the embodiment learns the base duty ratio command Dbase of the actuator 22a as the operation level of engine control, on condition that the target idle rotation speed Nei* enters the predetermined rotation speed range during idling of the engine 20 and that the difference ΔNe between the actual rotation speed Ne of the engine 20 and the target idle rotation speed Nei* enters the preset narrow range during idling of the engine 20 as the prerequisites. When the learning is incomplete, the control procedure rejects the up request of the target idle rotation speed Nei* sent from the air conditioner ECU 90 and prohibits the target idle rotation speed Nei* from being changed. The air conditioner ECU 90 may frequently send the up request of the target idle rotation speed Nei*, regardless of the current conditions of the vehicle driving system. The control procedure of the embodiment effectively prohibits a change of the target idle rotation speed Nei* under the condition of incomplete learning of the operation level of engine control. The prohibition of the change desirably keeps the target idle rotation speed Nei* within the predetermined rotation speed range and the difference ΔNe between the actual rotation speed Ne of the engine 20 and the target idle rotation speed Nei* within the preset narrow range, thus preventing failed fulfillment of the learning conditions and ensuring the sufficient learning opportunities of the operation level of engine control.

The control procedure of the embodiment executes the series of engine stop operations to stop the fuel injection by the injector 23 and prohibit the ignition of the spark plug 25, upon fulfillment of the engine stop conditions when the engine 20 is in the low load zone of the poor engine efficiency (for example, in the range of low vehicle speed V) and when the battery 45 has the desired SOC (state of charge). The control procedure of the embodiment controls the motor MG1 to crank the engine 20, regulates the valve-opening time of the injector 23 to ensure fuel injection by the injector 23 to a required level for a restart of the engine 20, and allows the ignition of the spark plug 25, so as to restart the engine 20, upon fulfillment of the engine restart conditions when the output powers of both the engine 20 and the motor MG2 are required to drive the wheels (for example, under acceleration) or when the low SOC of the battery 45 requires power generation of the motor MG1 to charge the battery 45. An auto stop of the engine 20 often leads to the low level of the cooling water temperature of the engine 20 and causes the frequent output of the up request of the target idle rotation speed Nei* from the air conditioner ECU 90. The technique of the invention is thus especially effective in this structure to ensure the sufficient learning opportunities of the base duty ratio command Dbase as the operation level of engine control.

The above embodiment regards application of the technique of the invention to the idle rotation speed control. The idle rotation speed control typically starts learning of the operation level of the engine 20 on condition that the target idle rotation speed Nei* enters the predetermined rotation speed range during idling of the engine 20 and that the difference ΔNe between the actual rotation speed Ne of the engine 20 and the target idle rotation speed Nei* enters the preset narrow range during idling of the engine 20 as the prerequisites. The technique of the invention is thus significantly effective in the idle rotation speed control of the embodiment.

The control procedure of the embodiment learns the base duty ratio command Dbase of the actuator 22a, which is a parameter correlated to the throttle opening, as the operation level of engine control. Accumulation of dust in some space or clearance in the throttle valve 22 may vary the intake air flow and interfere with accurate idle rotation speed control with the initially set base duty ratio command Dbase. There is accordingly the high demand of learning the base duty ratio command Dbase of the actuator 22a.

The learning of the operation level of engine control is performed once in every trip. The appropriate update of the learning value ensures adequate engine control.

Setting the rotational resistance of the rotor in the motor MG1 to zero causes idle rotation of the sun gear shaft 31a and disconnects the engine 20 from the ring gear shaft 32a (this is equivalent to the neutral gear position). The engine 20 thus readily shifts to a non-load operation or independent operation.

The embodiment discussed above is to be considered in all aspects as illustrative and not restrictive. There may be many modifications, changes, and alterations without departing from the scope or spirit of the main characteristics of the present invention.

The control procedure of the above embodiment learns the base duty ratio command Dbase or the reference operation amount of the actuator 22a to regulate the opening of the throttle valve 22, upon fulfillment of the learning conditions. The operation level of engine control to be learnt is, however, not restricted to the base duty ratio command Dbase but may be any parameter relating to the opening of the throttle valve 22, for example, the air flow running through the opening of the throttle valve 22 or the opening of the throttle valve 22.

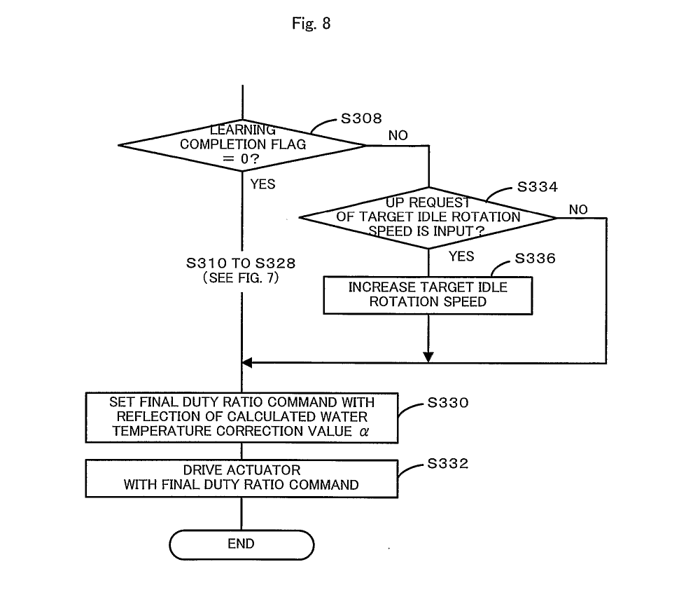

The idle rotation speed control routine executed in the embodiment may be modified as shown in FIG. 8. In the modified flow of FIG. 8, when the learning completion flag F is equal to 1 that represents completed learning at step S308, the engine ECU 50 determines whether the up request of the target idle rotation speed Nei* is received from the air conditioner ECU 90 (step S334). In the case of no input of the up request of the target idle rotation speed Nei*, the engine ECU 50 directly goes to step S330. Otherwise the engine ECU 50 increases the target idle rotation speed Nei* in response to the input up request (step S336), before going to step S330. The increased target idle rotation speed Nei* (for example, 1200 rpm) is used in a next cycle of the idle rotation speed control routine. This modification effectively prevents excessive prohibition of a change in target idle rotation speed Nei* and rejects a change request of the target idle rotation speed Nei* only in a required range.

In the description of the embodiment, the air conditioner ECU 90 outputs the up request of the target idle rotation speed Nei* to introduce the hot flow of cooling water of the engine 20 into the heater core 91 and raise the temperature of the air flow in the heater core 91. The air conditioner ECU 90 may also output the up request of the target idle rotation speed Nei* to increase the rotation speed of a compressor for compressing a cooling medium and enhance the cooling power, when the set temperature of the air conditioner is lower than the actual temperature in the passenger compartment in hot climates. The vehicle system other than the vehicle driving system is not limited to the air conditioner ECU 90, but may be a vehicle system of regulating a brake negative pressure and a vehicle system of controlling a power socket. The engine ECU 50 may determine whether a change request of the target idle rotation speed Nei* is received from any of these vehicle systems at step S310.

The above embodiment regards application of the electronic engine control device of the invention to the hybrid vehicle having the combination of the parallel configuration with the serial configuration. The technique of the invention is applicable to any hybrid vehicles under cooperative control of an engine and a motor, for example, to both parallel hybrid vehicles and series hybrid vehicles. The technique of the invention is not restricted to the hybrid vehicles but may also be adopted in motor vehicles under idle stop control, which stops an engine in response to a decrease in vehicle speed to substantially zero by the driver's depression of a brake pedal to a certain level at each short stop, for example, at a traffic light, during a drive. The similar functions and effects to those described in the above embodiment are expected in the motor vehicles under such idle stop control.

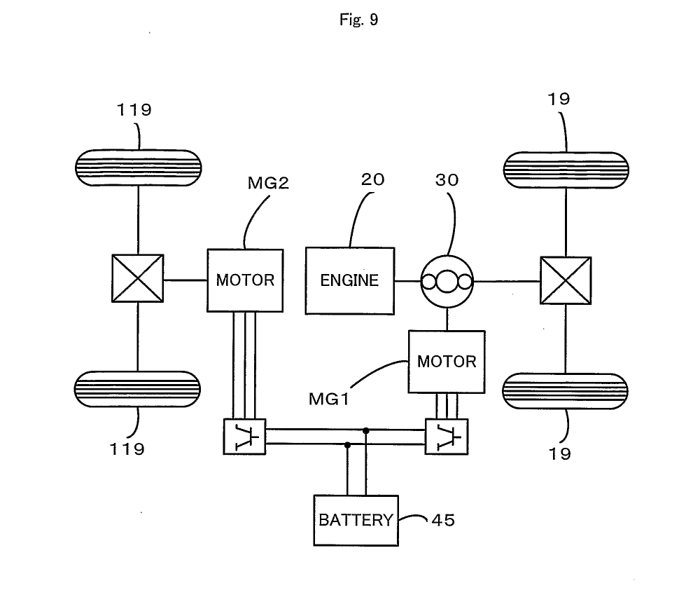

In the embodiment discussed above, the power of the motor MG2 is output to the ring gear shaft 32a. In one possible modification shown in FIG. 9, the power of the motor MG2 may be output to another axle (that is, an axle linked with wheels 119), which is different from an axle connected with the ring gear shaft 32a (that is, an axle linked with the wheels 19).

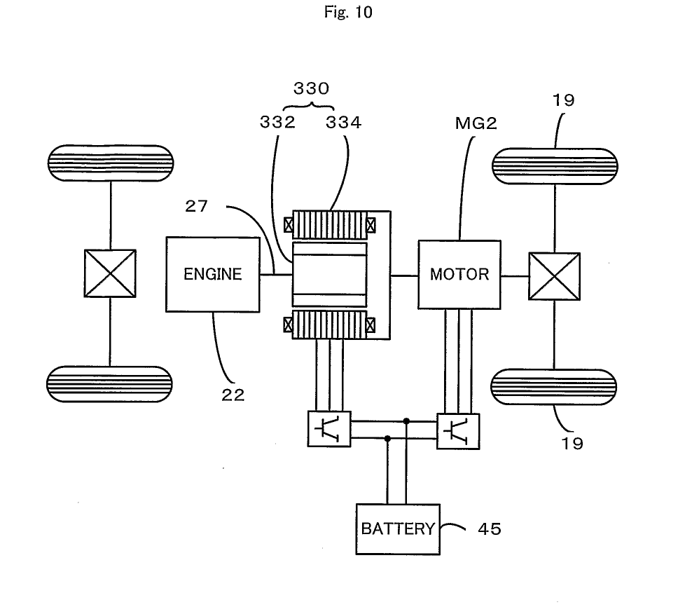

In the embodiment discussed above, the power of the engine 20 is output via the power distribution integration mechanism 30 to the ring gear shaft 32a functioning as the drive shaft linked with the drive wheels 19. In another possible modification of FIG. 10, the construction may have a pair-rotor motor 330, which has an inner rotor 332 connected with the crankshaft 27 of the engine 20 and an outer rotor 334 connected with the drive shaft for outputting the power to the drive wheels 19 and transmits part of the power output from the engine 20 to the drive shaft while converting the residual part of the power into electric power.

1-12. (canceled)

13. An electronic engine control device that controls an engine, said electronic engine control device comprising:
an operation level learning module that learns an operation level of engine control on condition that a target idle rotation speed is within a predetermined rotation speed range during an idle operation of the engine as one prerequisite;
a target rotation speed change module that varies the target idle rotation speed, in response to a change request of the target idle rotation speed sent from a vehicle system other than a vehicle driving system; and
a change prohibition module that prohibits said target rotation speed change module from changing the target idle rotation speed, when the learning of the operation level of engine control by said operation level learning module is incomplete.

14. An electronic engine control device that controls an engine, said electronic engine control device comprising:
an operation level learning module that learns an operation level of engine control on condition that a difference between an actual rotation speed of the engine and a target idle rotation speed is within a preset narrow range during an idle operation of the engine as one prerequisite;
a target rotation speed change module that varies the target idle rotation speed, in response to a change request of the target idle rotation speed sent from a vehicle system other than a vehicle driving system; and
a change prohibition module that prohibits said target rotation speed change module from changing the target idle rotation speed, when the learning of the operation level of engine control by said operation level learning module is incomplete.

15. An electronic engine control device in accordance with claim 13, wherein said change prohibition module allows said target rotation speed change module to change the target idle rotation speed after the learning of the operation level of engine control by said operation level learning module is completed.

16. An electronic engine control device in accordance with claim 14, wherein said change prohibition module allows said target rotation speed change module to change the target idle rotation speed after the learning of the operation level of engine control by said operation level learning module is completed.

17. An electronic engine control device in accordance with claim 13, wherein the engine has a water-cooled mechanism, and the change request is an up request of the target idle rotation speed output from an electronic heater control unit, which controls a heater of recovering waste heat of cooling water in the engine.

18. An electronic engine control device in accordance with claim 14, wherein the engine has a water-cooled mechanism, and the change request is an up request of the target idle rotation speed output from an electronic heater control unit, which controls a heater of recovering waste heat of cooling water in the engine.

19. An electronic engine control device in accordance with claim 17, said electronic engine control device further comprising:
a stop restart control module that stops the engine upon fulfillment of a preset engine stop condition, while restarting the engine upon subsequent fulfillment of a preset engine restart condition.

20. An electronic engine control device in accordance with claim 18, said electronic engine control device further comprising:
a stop restart control module that stops the engine upon fulfillment of a preset engine stop condition, while restarting the engine upon subsequent fulfillment of a preset engine restart condition.

21. An electronic engine control device in accordance with claim 13, wherein the engine control is idle rotation speed control.

22. An electronic engine control device in accordance with claim 14, wherein the engine control is idle rotation speed control.

23. An electronic engine control device in accordance with claim 13, wherein the operation level of engine control is an operation amount of an actuator for regulating a throttle opening.

24. An electronic engine control device in accordance with claim 14, wherein the operation level of engine control is an operation amount of an actuator for regulating a throttle opening.

25. An electronic engine control device in accordance with claim 13, wherein the operation level of engine control is learnt at least once in each trip or at least once in a preset time period.

26. An electronic engine control device in accordance with claim 14, wherein the operation level of engine control is learnt at least once in each trip or at least once in a preset time period.

27. A vehicle that is equipped with an electronic engine control device in accordance with claim 13.

28. A vehicle that is equipped with an electronic engine control device in accordance with claim 14.

29. An electronic engine control method that controls an engine, said electronic engine control method comprising the steps of:
(a) learning an operation level of engine control on condition that a target idle rotation speed is within a predetermined rotation speed range during an idle operation of the engine as one prerequisite; and
(b) prohibiting a target idle rotation speed from being changed in response to a change request of the target idle rotation speed sent from a vehicle system other than a vehicle driving system, when the learning of the operation level of engine control in said step (a) is incomplete.

30. An electronic engine control method that controls an engine, said electronic engine control method comprising the steps of:
(a) learning an operation level of engine control on condition that a difference between an actual rotation speed of the engine and a target idle rotation speed is within a preset narrow range during an idle operation of the engine as one prerequisite; and
(b) prohibiting a target idle rotation speed from being changed in response to a change request of the target idle rotation speed sent from a vehicle system other than a vehicle driving system, when the learning of the operation level of engine control in said step (a) is incomplete.

31. An electronic engine control method in accordance with claim 29, wherein said step (b) allows for change of the target idle rotation speed in response to a change request of the target idle rotation speed, according to the change request, after the learning of the operation level of engine control is completed in said step (a).

32. An electronic engine control method in accordance with claim 30, wherein said step (b) allows for change of the target idle rotation speed in response to a change request of the target idle rotation speed, according to the change request, after the learning of the operation level of engine control is completed in said step (a).
